(19) United States
(12) Patent Application Publication
(10) Pub. No.: US 2007/0033091 A1
(43) Pub. Date: Feb. 8, 2007

(54) Method And System For Managing A Meeting

(76) Inventors: Frederick Rajendran Ravikumar, Bangalore (IN); Subramaniam Tirumalaiswamy, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/462,049

(22) Filed: Aug. 3, 2006

(30) Foreign Application Priority Data
Aug. 8, 2005 (IN) 1099/CHE/2005

(51) Int. Cl. G06F 15/02

(52) U.S. Cl. 705/9

(57) ABSTRACT

A computer implemented method for managing a meeting is provided. The method includes scheduling a meeting, selecting one or more participants for the scheduled meeting, sending an invitation for the scheduled meeting to the one or more participants wherein each participant is able to add a discussion item for the scheduled meeting when the participant accepts the invitation, consolidating the discussion items for the scheduled meeting added by the participant who accepted the invitation, selecting at least one discussion item from the consolidated discussion items as an item for an agenda of the scheduled meeting and informing the one or more participants on the agenda of the scheduled meeting.

### FIELD OF THE INVENTION

The invention relates generally to meeting management, and more particularly, to a method and system for managing a meeting.

### BACKGROUND OF THE INVENTION

Meetings, regardless of whether it is face-to-face or virtual, are generally used as a management communication tool for keeping people informed and motivated, generating new ideas or policies, and making decisions for some matters. A meeting can foster relationship among people by encouraging participation and interaction. It can also foster a person's growth and ownership in a company. Therefore, many organizations recognize the importance of meetings and schedule meetings within and outside their organizations on a regular basis.

A meeting may be managed manually by an appointed meeting coordinator. The meeting coordinator schedules a meeting on a certain date and sends out emails to other people to invite them to attend the meeting. The coordinator has to find out the objective of the meeting and determine the agenda. Details of the meeting, such as meeting time, venue and agenda, are normally typed into the content of the email. During the meeting, the chairman of the meeting goes through each item of the agenda and a person may take the minutes of the meeting. After the meeting, each person would remember their own action items and perform them accordingly. The chairman or the coordinator may also keep a record of all the action items to be performed, and sends reminders to the respective people for performing the action items. The minutes of the meeting may also be sent out subsequently after the meeting to the people who attended the meeting, or to those who have one or more action items to complete.

The manual process for managing a meeting is feasible when the meeting involves only a few people and has few items on the agenda. However, when the meeting involves a large group of people, the coordination of the meeting becomes tedious. Moreover, if the meeting has generated many action items, it is very difficult to keep record on whether each of the action items has been performed by the respective people.

Electronic calendars such as Microsoft Outlook may aid the coordinator in managing the meeting by providing various options such as data fields for the coordinator to provide meeting details, adding attendees for the meeting, sending invitations to the attendees, and sending reminders to the attendees for the meeting. However, such electronic calendars do not help the coordinator to consolidate the actions item resulting from the meeting. The electronic calendars also do not have any post-meeting options such as tracking whether the action items are performed by the respective people, or sending minutes of the meeting to the attendees or to those who have action items to complete, regardless whether they were the attendees of the meeting.

### SUMMARY OF THE INVENTION

In an embodiment, a computer implemented method for managing a meeting is provided. The method includes scheduling a meeting, selecting one or more participants for the scheduled meeting, sending an invitation for the scheduled meeting to the one or more participants wherein each participant is able to add a discussion item for the scheduled meeting when the participant accepts the invitation, consolidating the discussion items for the scheduled meeting added by the participant who accepted the invitation, selecting at least one discussion item from the consolidated discussion items as an item for an agenda of the scheduled meeting and informing the one or more participants on the agenda of the scheduled meeting.

### BRIEF DESCRIPTION OF THE DRAWINGS

The embodiments of the invention will be better understood in view of the following drawings and the detailed description.

FIG. 1 shows a block diagram of a system for managing a meeting according to an embodiment.

FIG. 2 shows a flow chart of a meeting management process according to an embodiment.

FIG. 3 shows a flow chart of an example of the meeting management process before the meeting according to an embodiment.

FIG. 4 shows a flow chart of an example of the meeting management process during and after the meeting according to an embodiment.

FIG. 5 shows an example of a website for logging in to access an application program hosting the system for managing the meeting according to an embodiment.

FIG. 6 shows an example of a “schedule a meeting” GUI page according to an embodiment.

FIG. 7 shows an example of an invitation email sent to participants of the meeting according to an embodiment.

FIG. 8 shows an example of an agenda sent to the participants of the meeting according to an embodiment.

FIG. 9 shows an example of a page for taking attendance of the participants of the meeting according to an embodiment.

FIG. 10 shows an example of a page for updating the items of the agenda according to an embodiment.

FIG. 11 shows an example of an updated list of items generated during the meeting according to an embodiment.

FIG. 12 shows an example of the meeting minutes sent to the participants of the meeting according to an embodiment.

FIG. 13 shows an example of a summary of meetings of the participants according to an embodiment.

### DETAILED DESCRIPTION OF THE INVENTION

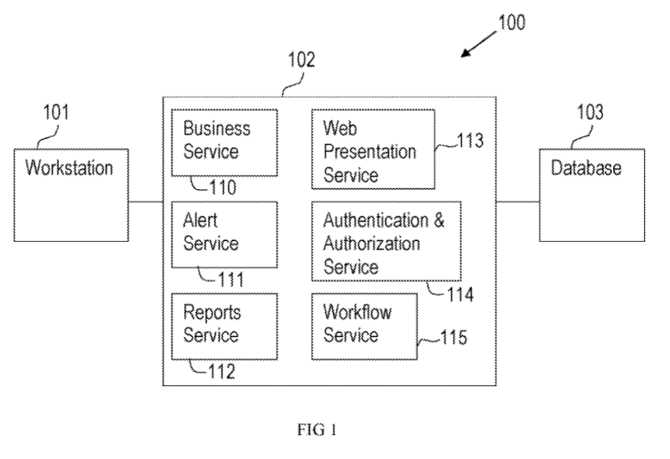

FIG. 1 shows a system 100 for managing a meeting according to an embodiment. The system 100 includes a computer workstation 101, a server 102 and a database 103. The database 103 includes various data fields which correspond to different details of the meeting. Examples of the meeting details include, but not limited to, meeting ID, date, time, duration, venue, objective, agenda review date and any documents uploaded. The server 102 includes an application program which interfaces the database 103 with the workstation 101. The workstation 101 allows a user to interact with the application program to manage the meeting.

The application program resided in the server 102 provides various services including business service 110, alert service 111, reports service 112, web presentation service 113, authentication and authorization service 114, and workflow service 115. The business service 110 regulates the functioning of the various services and the flow of information between the user from the workstation 101, the server 102 and the database 103. When the user provides input at the work station 101, the business service 110 interprets the input and instructs the other services to respond to the input accordingly. For example, if the user wants to view a summary of all meetings scheduled, the business service 110 retrieves the information of all the meetings from the database 103, instructs the reports service 112 to generate a report containing the information on all the meetings and instructs the web presentation service 113 to present the report to the user at the workstation 101.

The alert service 111 alerts the user of any event, such as an upcoming meeting or an action which needs to be performed, by sending email reminders to the user. The reports service 112 generates report requested by the user. The web presentation service 113 provides a Graphical User Interface (GUI) at the workstation 101. The user accesses the various services of the application through the GUI at the workstation 101. Examples of the various GUI presented to the user will be described later. The authentication and authorization service 114 prevents unauthorized use of the system 100 by authenticating the identity of the user. The workflow service 115 controls the flow of the meeting managing process, such as the steps for scheduling a meeting.

The workstation 101 may be implemented using any computer and laptop. The workstation 101 is connected to the server 102 via the Internet in an embodiment. The application program is hosted on the Internet by the server 102. The server 102 may be implemented using the Microsoft Internet Information Services (IIS) server in an embodiment. It is also possible to implement the server 102 using other types of servers, for example the Apache Tomcat server, in other embodiments. The database 103 may be implemented using the Microsoft SQL Server. Since the system 100 is implemented on the Internet, the workstation 101 of the system 100 may include any computers or laptops which are connected to the Internet.

In an alternative embodiment, the workstations 101 may be connected directly to the server 102. The server 102 may be a personal computer which is connected with the workstation 101 and the database 103, and runs the application program for managing a meeting. In other words, the system 100 may be implemented in an offline manner.

The application residing in the server 102 is a web-based 3-tier application in an embodiment. A first layer is an application front end layer which contains Microsoft Active Server Pages (ASP). A second layer is a business logic layer which is written using Microsoft's VBScript, JScript and ASP components. A third layer is a database layer which contains Microsoft Structured Query language (SQL) server and stores the data and information.

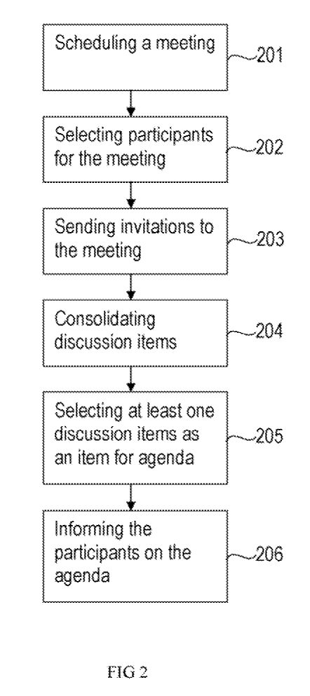

FIG. 2 shows a flow chart of a meeting management process according to an embodiment. Step 201 includes scheduling a meeting. A meeting coordinator schedules the meeting by entering meeting details through a GUI page at the workstation 101. As described earlier, the meeting details may include meeting date, time, duration, venue, meeting objective and/or agenda review date. Documents may also be uploaded through the GUI page at this stage. Step 202 includes selecting participants to attend the meeting. The participants may be selected by the coordinator from the same GUI page in step 201, or through another GUI page. The participants may also be selected from a predefined list or newly added by the coordinator.

Step 203 includes sending out invitations to the selected participants. The invitation to the meeting contains the meeting details. Each participant may accept or reject the invitation to the meeting at the workstation 101. More than one workstation 101 may be provided in another embodiment, and the participant may use any one of the workstations 101 to accept or reject the invitation. Once the participant accepts the invitation, each of the participants is able to add items for discussion during the scheduled meeting.

Step 204 includes consolidating the discussion items submitted by the participants who accepted the invitation to the scheduled meeting. Open items from the previously occurred meetings may also be added by the coordinator. Step 205 includes selecting one or more items from the consolidated discussion items as items for the agenda. The coordinator is able to view all the discussion items added by the participants. Depending on the objectives of the meeting or other factors, the coordinator selects one or more items for the agenda from the discussion items. Step 206 includes informing the participants on the items for the agenda for the scheduled meeting. Specifically, the agenda items are sent to the participants who accepted the invitation to the meeting.

During the scheduled meeting, the system 100 also allows the coordinator or a chairperson of the meeting to go through each agenda item, write meeting minutes, and update a corresponding status of agenda item. The updating of the status of each agenda items includes closure of the item or assigning a responsible owner and an expected date of closure for the item. The items which are not closed are classified as action items to be completed before the expected date of closure. After the meeting, the coordinator or the chairperson closes the meeting and the system 100 sends the meeting minutes, the action items and closing comments, if any, to the participants of the meeting. The system 100 further allows the coordinator to monitor whether the action items have been completed before their respective expected date of closure, and send reminders if they have not been completed.

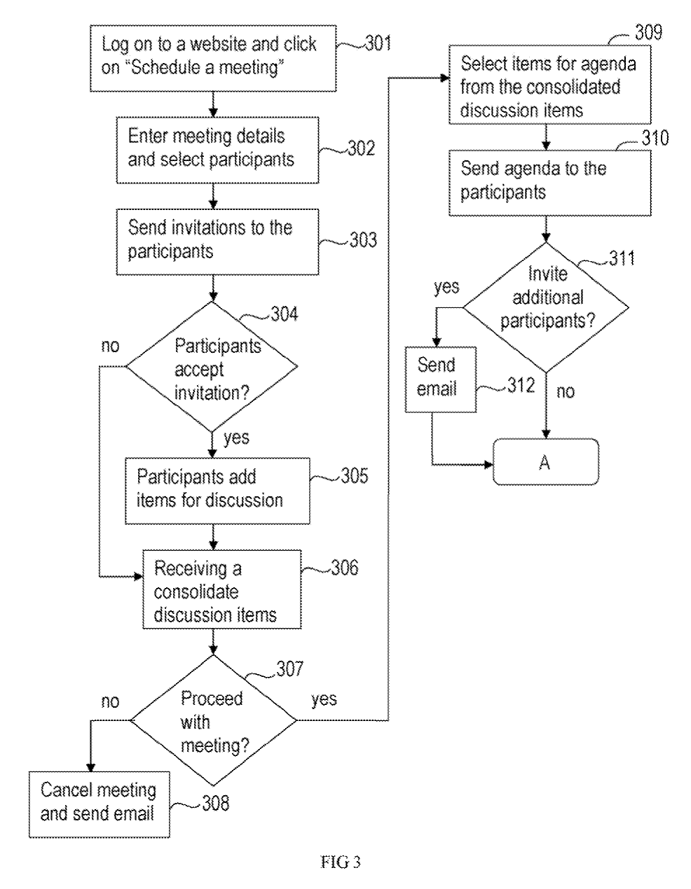

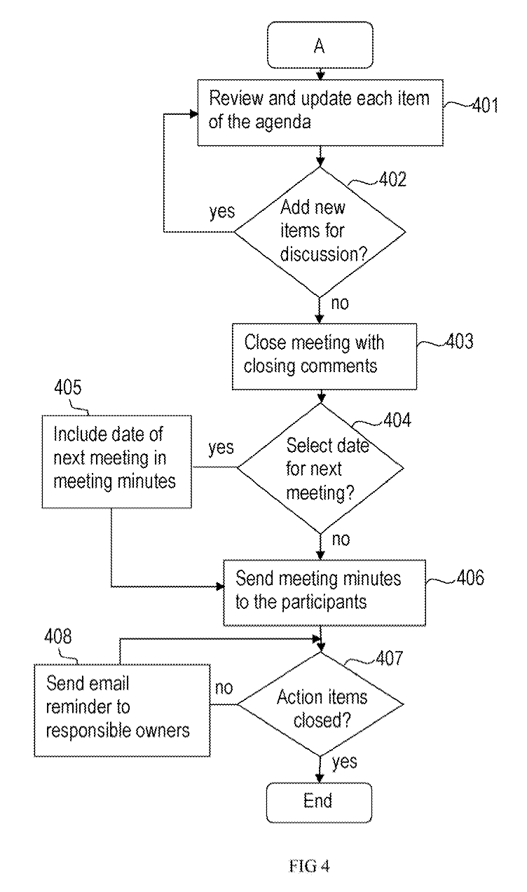

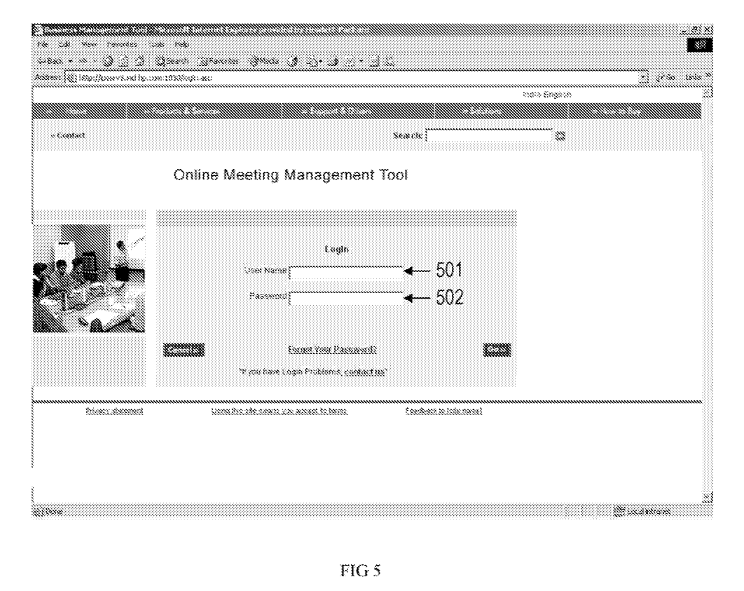

FIG. 3 and FIG. 4 show a flow chart of a detailed example of the meeting management process according to an embodiment. FIG. 3 relates to the process before the meeting and FIG. 4 relates to the process during and after the meeting. FIG. 5-12 show examples of GUI pages at different stages of the process for managing the meeting.

The meeting management process before the meeting shall now be described with reference to the flow-chart of FIG. 3, and in conjunction with FIGS. 5-8. In FIG. 3, step 301 includes logging on to a website which accesses the application resided in the server 102 for managing the meeting. At the website, the coordinator logs in to use the application program to schedule a meeting. Such authentication of the identity of the coordinator prevents unauthorized access to the application program. An example of a website for the coordinator to log in to access the application program is shown in FIG. 5. As seen from FIG. 5, the login credentials include User Name 501 and Password 502. After the coordinator has logged in to the application program, he or she selects a “schedule a meeting” link to load a “schedule a meeting” GUI page.

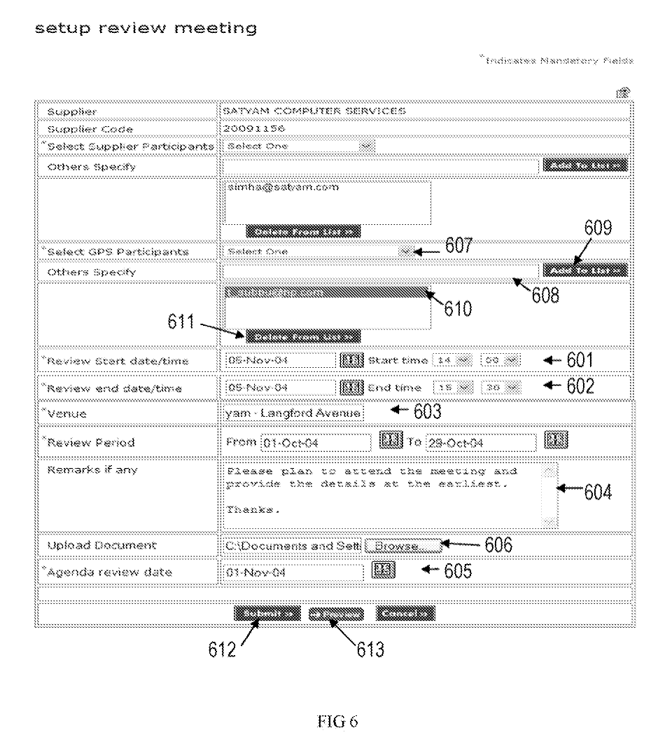

Step 302 (in FIG. 3) includes entering meeting details and selecting participants for the scheduled meeting. The meeting details are entered into various data fields provided on the “schedule a meeting” GUI page. The “schedule a meeting” GUI page also includes a data field for allowing the coordinator to select the desired participants for the scheduled meeting. FIG. 6 shows an example of the “schedule a meeting” GUI page. The GUI page includes a “Review Start date/time” data field 601 for entering the date and time of the scheduled meeting. A “Review end date/time” data field 602 is also included for entering the date and time the meeting is scheduled to end. By comparing the entries in both the data fields 601, 602, the duration of the meeting can be computed.

The GUI page of FIG. 6 also includes a “Venue” data field 603 for entering the venue of the scheduled meeting. The objective or purpose of the meeting can also be entered into a “Remarks if any” data field 604. A “Agenda review date” data field 605 is also included for the coordinator to enter a date when the items for the agenda of the meeting has to be finalized. A document may also be uploaded to the server 102 by clicking on the “Browse” button 606, and selecting the desired document to be uploaded.

The coordinator selects the participants for the scheduled meeting from a drop down menu 607 provided in the “schedule a meeting” GUI page as shown in FIG. 6. If a desired participant is not found from the drop down menu 607, the coordinator may add the desired participant by typing the email address of the desired participant in a “Others Specify” data field 608 and clicking on a “Add To List” button 609. The selected participants are displayed in a data field 610. Any one of the selected participants may be deleted by highlighting the participant to be desired to be deleted, and clicking on a “Delete From List” button 611.

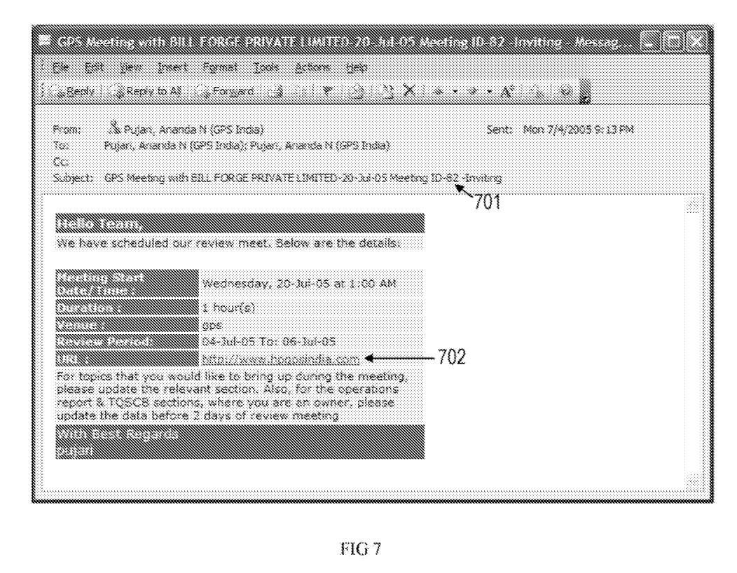

Step 303 (FIG. 3) includes sending an invitation to each of the participants for the scheduled meeting. The invitation is sent to the participants by clicking on a “Submit” button 612 provided in the “schedule a meeting” GUI page of FIG. 6. The coordinator may also preview the contents of the meeting by clicking on a “Preview” button 613, before sending the invitation to the participants. The invitation sent out to the participants includes the meeting details entered in Step 302. FIG. 7 shows an example of the invitation sent to the participants. The invitation is sent in a form of an email. In addition to the meeting details, the invitation also includes a meeting ID 701 and a URL 702 of the website for accessing the application.

Step 304 (FIG. 3) includes determining whether each of the participants accepts the invitation to the meeting. After the participants received the meeting invitation, they may accept or reject the invitation with appropriate comments, if any. The participants log on to the website to accept or reject the meeting associated with the meeting ID. Each participant is able to add items for discussion in Step 305 after accepting the invitation.

Step 306 includes receiving a consolidated list of all the discussion items added by the participants who accepted the invitation. In addition, the coordinator also receives a list of participants who accepted or rejected the invitation. The coordinator may also log on to the website and view the list of the participants who accepted or rejected the invitation, and the consolidated list of the discussion items. The coordinator decides whether to proceed with the meeting depending on the attendance of the participants and the consolidated items for discussions in Step 307. If the coordinator decides not to proceed with the meeting, the meeting is cancelled in Step 308, and comments are sent out in an email to the participants.

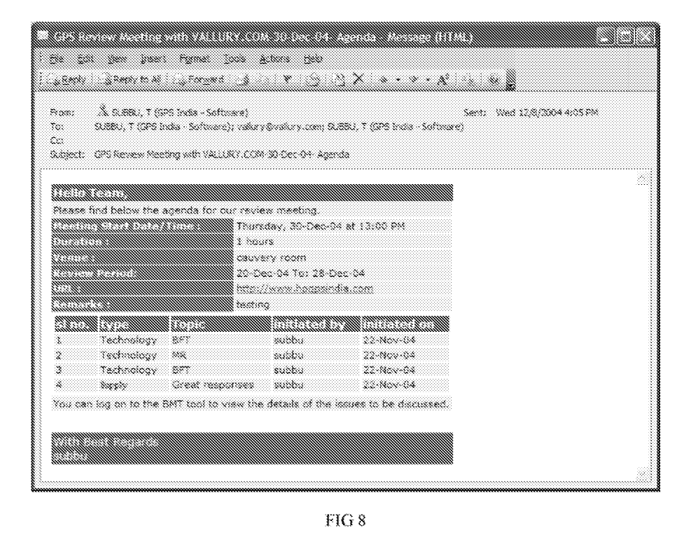

If the coordinator decides to proceed with the meeting, the coordinator selects items for the agenda from the consolidate discussion items in Step 309. Discussion items which are not selected as items for the agenda are put under an Open Items List. Items under the Open Items List are available to be selected as items for the agenda of subsequent meetings. Step 310 includes sending the agenda to the participants. FIG. 8 shows an example of the agenda sent to the participants.

The coordinator may invite additional participants to the meeting in Step 311. If additional participants are to be invited, invitations are sent to the additional participants in Step 312. The agenda may also be sent to the additional participants together with the invitation, or in a separate email. Although the additional participants are invited only after the agenda has been finalized in the example shown in the flow-chart of FIG. 3, it is possible to invite additional participants any time before the meeting. If the additional participants are invited before the items for the agenda are finalized, the additional participants are also able to add items for discussion.

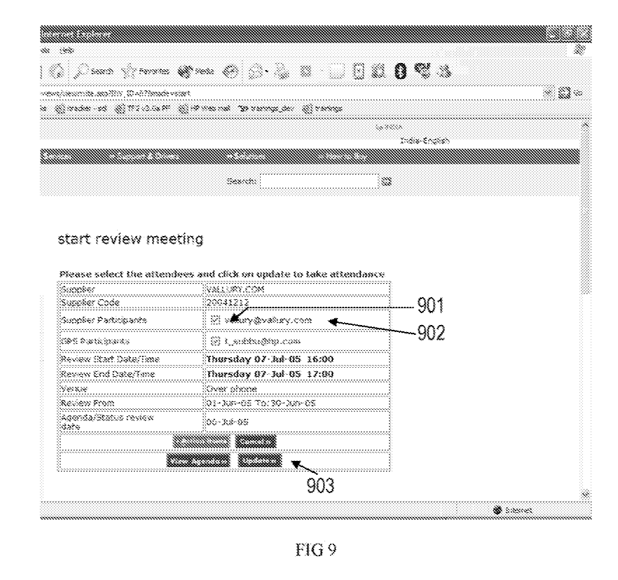

The meeting management process during and after the meeting shall now be described with reference to FIG. 4, and in conjunction with FIGS. 9-12. The coordinator or a chairperson of the meeting may start the meeting by taking the attendance of the participants. An example of a GUI page for taking the attendance of the participants is shown in FIG. 9. In the example shown in FIG. 9, the coordinator click the check box 901 beside each participant 902, and click the “Update” button 903 to take the attendance of the participants.

Step 401 of FIG. 4 includes reviewing each item of the agenda and updating the item accordingly. The updating of the item includes closing the item, or defining the item as an action item with an expected date of closure and assigning a person responsible for closing the item before the expected date of closure. After all the items of the agenda have been reviewed, the chairperson may add new items for discussion in Step 402. Any new items added are reviewed and updated accordingly in Step 401. The reviewed and updated items of agenda form the minutes of the meeting.

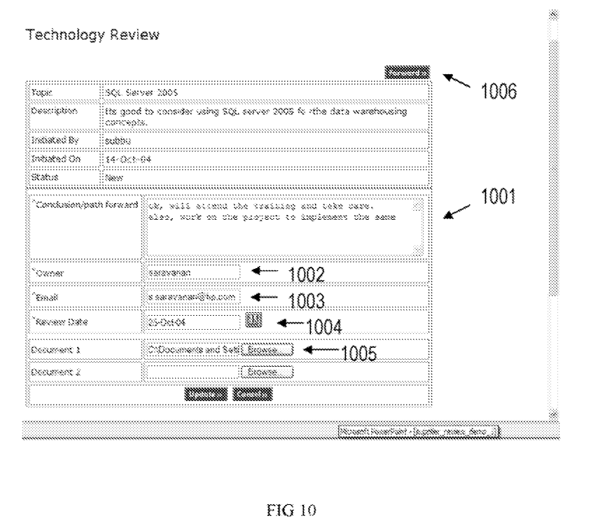

FIG. 10 shows an example of a page for updating the agenda item by defining the item as an action item with an expected date of closure and assigning a person responsible for closing the action item. Appropriate comments may be inserted into a “conclusion/path forward” data field 1001. The responsible owner for the action item is assigned by entering the name and email address of the owner into an “Owner” data field 1002 and an “Email” data field 1003, respectively. The expected date of closure is entered into the “Review Date” data field 1004. A document may also be uploaded onto the server 102 by clicking on the “Browse” button 1005. The action item may also be forwarded to another person by clicking on the “Forward” button 1006.

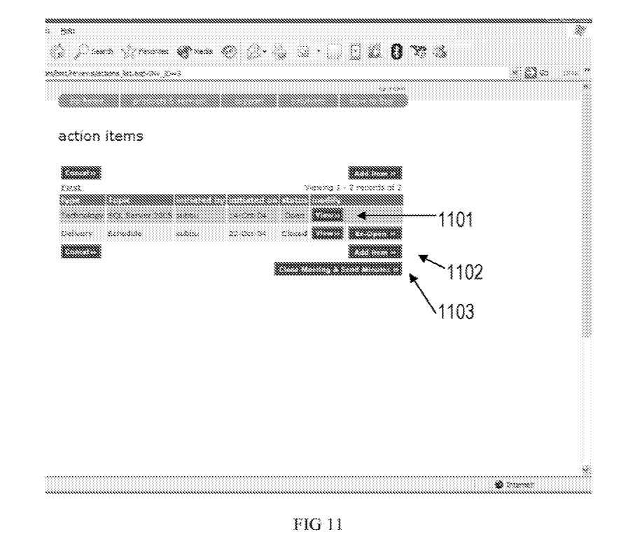

After all the items of the agenda have been reviewed, the coordinator or the chairperson may close the meeting with closing comments in Step 403. FIG. 11 shows an example of an updated list of items during the meeting. The status of the items may be modified by clicking the “View” button 1101. New items can be added for discussion during the meeting as described in Step 402 by clicking the “Add Item” button 1102. The coordinator may also close the meeting by clicking the “Close Meeting & Send Minutes” button 1103 as described in Step 403.

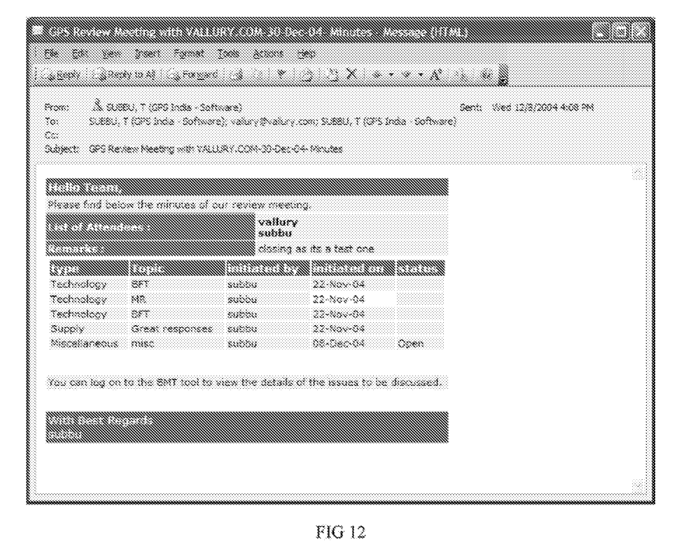

Step 404 includes allowing the coordinator or the chairperson to select a date for a next meeting. If the date for the next meeting is selected, the date of the next meeting is included in the minutes of the meeting in Step 405. The meeting minutes with the date of the next meeting are sent out to the participants in Step 406. If the date of the next meeting is not selected, the meeting minutes are sent out to the participants in Step 406 without the date of the next meeting. FIG. 12 shows an example of the meeting minutes sent to the participants. It is also possible to send the meeting minutes to one or more persons who are not participants of the meeting, but have been assigned as the person responsible for closing one of the action items.

Once the meeting is over, a status of the meeting corresponding to the meeting ID is reflected as “occurred”. The next meeting has a corresponding status of “planned”. The coordinator or the person responsible for closing one of the action items may log on to the website to update the action items with appropriate comments. Updating of action items include entering comments, postponing the expected date of closure, closing the action items, or forwarding the action item to another person. Step 407 includes determining whether any of the action items are closed by the expected date of closure. If one of the action items is not close by the expected date of closure, a reminder is sent to the person responsible for closing that action item in Step 408.

All the items under the Open Items List (those which were not selected as agenda items) and the action items which are not closed are reflected to the coordinator when planning for the next meeting. Even agenda items which are not reviewed during previous meetings may be reflected to the coordinator. Any previously closed agenda items or action items may be re-opened by the coordinator if he or she feels that the items have not been completed.

The meeting management system described above allows the coordinator to schedule and manage a meeting which takes place on a later date as described in the flow-charts of FIG. 3 and FIG. 4 according to an embodiment. It is also possible to use the meeting management system to schedule a meeting immediately, and manages the meeting progress according to another embodiment. In this embodiment, the coordinator or the chairperson adds new items for discussion during the meeting, and updates the status according to Steps 401 to 408 in FIG. 4.

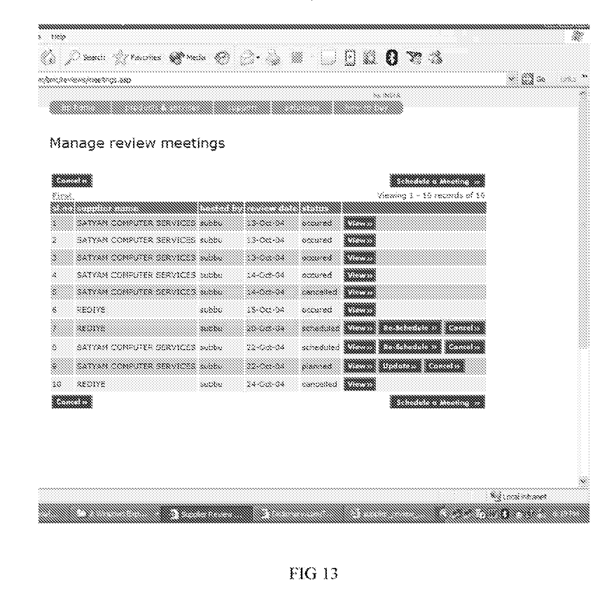

The meeting management system according to the embodiment allows the coordinator to have a summary of all the meetings of the participants and their availability. An example of the summary of meetings is shown in FIG. 13. The coordinator is also able to generate a complete report of all the action items for a particular participant or for all the participants. Thus, the coordinator is able to efficiently track the action items resulted from the meeting for closure. The summary of meetings, action items and their statuses can also be exported to an external program, such as Microsoft Excel, for offline viewing or send to management as updates.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A computer implemented method for managing a meeting, comprising:
scheduling a meeting;
selecting at least one participant for the scheduled meeting;
sending an invitation for the scheduled meeting to the at least one participant, wherein the at least one participant is able to add a discussion item for the scheduled meeting when the participant accepts the invitation;
consolidating the discussion items for the scheduled meeting added by the at least one participant who accepted the invitation;
selecting at least one discussion item from the consolidated discussion items as an item for an agenda of the scheduled meeting; and
informing the at least one participant on the agenda of the scheduled meeting.

2. The computer implemented method of claim 1, wherein scheduling a meeting comprises entering at least one of the following meeting details:
Meeting date;
Meeting time;
Meeting duration;
Venue;
Purpose of the meeting; and
Agenda review date.

3. The computer implemented method of claim 2 further comprising uploading a document for the scheduled meeting.

4. The computer implemented method of claim 1 further comprising putting at least one discussion item which is not selected as an item for the agenda under an open items list, wherein the discussion item under the open items list is available to be selected as an item for the agenda of a next meeting.

5. The computer implemented method of claim 1 further comprising sending a reminder if the items for the agenda of the scheduled meeting is not determined after a predefined date.

6. The computer implemented method of claim 1 further comprising inviting additional participants for the scheduled meeting.

7. The computer implemented method of claim 1 further comprising:
reviewing each item of the agenda during the scheduled meeting;
updating the status of each reviewed item of the agenda; and
closing the scheduled meeting.

8. The computer implemented method of claim 7 further comprising adding a new item of the agenda for review during the scheduled meeting and updating the status of the new reviewed item of the agenda.

9. The computer implemented method of claim 7 further comprising selecting a date for a next meeting and informing the at least one participant the date of the next meeting.

10. The computer implemented method of claim 7, wherein updating the status of each reviewed item of the agenda comprises:
closing the reviewed item with closing comments; or
defining an expected date of closure for the reviewed item and assigning an owner to be responsible for closing the reviewed item by the expected date of closure.

11. The computer implemented method of claim 10 further comprising sending closed meeting minutes to the at least one participant of the scheduled meeting and/or to owners who are not participants of the scheduled meeting but are responsible for closing the reviewed items.

12. The computer implemented method of claim 10 further comprising performing at least one of the following for the reviewed item having an expected date of closure:
adding comments to the reviewed item;
changing the expected date of closure of the reviewed item;
forwarding the reviewed item to another person; and
closing the reviewed item.

13. The computer implemented method of claim 10 further comprising sending a reminder to the owner responsible for closing the reviewed item if the reviewed item is not closed by the expected date of closure.

14. A system for managing a meeting, comprising:
a server having an application residing thereon which is adapted to perform the following:
allow a user to schedule a meeting by entering meeting details, and to select at least one participant for the scheduled meeting;
send an invitation for the scheduled meeting to be sent to the at least one participant;
allow the at least one participant to add a discussion item for the scheduled meeting;
consolidate the discussion items added by the at least one participant;
allow the user to select at least one discussion item from the consolidated discussion items as an item for an agenda of the scheduled meeting; and
inform the at least one participant on the agenda of the scheduled meeting,
at least one workstation connected to the server for allowing the user and the at least one participant to interact with the application residing in the server; and
a database connected to the server for storing meeting details and the discussion items.

15. The system of claim 14, wherein the meeting details comprise at least one of the following:
meeting date;
meeting time;
meeting duration;
venue;
purpose of the meeting; and
agenda review date.

16. The system of claim 14, wherein the application is further adapted to put at least one discussion item which is not selected as an item for the agenda under an open items list, wherein the discussion item under the open items list is available to be selected as an item for the agenda of a next meeting.

17. The system of claim 14, wherein the application is further adapted to send a reminder if the items for the agenda of the scheduled meeting is not determined after a predefined date.

18. The system of claim 14, wherein the application is further adapted to allow the user to update the status of each item of the agenda reviewed during the scheduled meeting.

19. The system of claim 18, wherein the updating of the status of each reviewed item of the agenda comprises:
closing the reviewed item with closing comments; or
defining an expected date of closure for the reviewed item and assigning an owner to be responsible for closing the reviewed item by the expected date of closure.

20. The system of claim 19, wherein the application is further adapted to allow the user to perform at least one of the following for the reviewed item having an expected date of closure:
adding comments to the reviewed item;
changing the expected date of closure of the reviewed item;
forwarding the reviewed item to another person; and
closing the reviewed item.

21. The system of claim 14, wherein the application residing on the server is a 3-layered application comprising an application front end layer, a business logic layer and a database layer.

22. The system of claim 14, wherein a graphic user interface is generated by the application, and is presented to the user at the workstation, wherein the user schedule the meeting by entering the meeting details into respective data fields of the graphical user interface.

23. The system of claim 14 further comprising an email module in the server for sending out the invitations for the scheduled meeting and reminders to the plurality of participants.

24. A computer readable medium having stored thereon one or more sequences of instructions for causing one or more processors to perform the method for managing a meeting, the method comprising:
scheduling a meeting;
selecting at least one participant for the scheduled meeting;
sending an invitation for the scheduled meeting to the at least one participant, wherein the at least one participant is able to add a discussion item for the scheduled meeting when the participant accepts the invitation;
consolidating the discussion items for the scheduled meeting added by the at least one participant who accepted the invitation;
selecting at least one discussion item from the consolidated discussion items as an item for an agenda of the scheduled meeting; and
informing the at least one participant on the agenda of the scheduled meeting.
